(19) United States
(12) Patent Application Publication
(10) Pub. No.: US 2015/0242569 A1
(43) Pub. Date: Aug. 27, 2015

(54) NETWORK-BASED SYSTEMS AND METHODS FOR META-ANALYSIS OF HEALTHCARE INFORMATION

(71) Applicants: Sandeep Antony, Columbia, MD (US); Scott Afzal, Washington, DC (US); David Horrocks, Baltimore, MD (US); Yedong Tang, Columbia, MD (US)

(72) Inventors: Sandeep Antony, Columbia, MD (US); Scott Afzal, Washington, DC (US); David Horrocks, Baltimore, MD (US); Yedong Tang, Columbia, MD (US)

(21) Appl. No.: 14/189,306

(22) Filed: Feb. 25, 2014

(51) Int. Cl. G06F 19/00

(52) U.S. Cl. CPC G06F 19/322

(57) ABSTRACT

Networks and methods include or use a computer hardware processor to manage healthcare information between healthcare sources and providing subscribers. Subscriber requests and healthcare information about patients are used in the networks and methods to provide only responsive content to subscribers. Networks and methods screen healthcare with criteria in the subscriber requests, and only when the information matches the criteria, provides a deliverable based on the healthcare information, in desired format and fashion, to the subscriber associated with the matching criteria. Systems and methods also perform meta-analysis on received healthcare information itself. The meta-analysis is used to correct or enhance the deliverable with things like typographical correction, auto-subscribe/unsubscribe, historical healthcare analysis, addition of relevant alert information, and other conditioning.

### BACKGROUND

Healthcare information, including patient medical records and activities, facility encounters, insurance information, provider institutions, billing data, government healthcare support information, etc., across a large population can be aggregated in a Health Information Exchange (HIE) or similar database. For example, providers, insurers, and/or or governmental bodies may gather relevant healthcare information for all patients, providers, insurers, and other healthcare actors in exchanges. An example of a related art HIE may be Maryland's CRISP network and associated Master Patient Index (MPI). FIG. 1 is an illustration of a related health information exchange system 10. As shown in FIG. 1, system 10 includes a HIE 15 having a healthcare information routing and demographic matching structure 30, healthcare information database 21, and a healthcare information logic structure 20.

Healthcare information routing and demographics matching structure 30 may be a digitized or computer-based system that facilitates entry, gathering, and organization of healthcare information from one or more providers 50. For example, providers 50 may be emergency rooms, outpatient clinics, urgent care offices, pharmacies, laboratories, assisted living facilities, visiting nurse networks, etc. Providers 50 typically provide a variety of healthcare information to HIE 15 via healthcare information routing and demographics matching structure 30. For example, a provider 50 may provide clinical feeds 36, patient Admit-Discharge-Transfer (ADT) messages 35, and/or any other healthcare information to healthcare information routing and demographics matching structure 30. The healthcare information, including content from clinical feeds 36 and ADT messages 35, may include many different types of relevant healthcare records created in response to provider treatment and other provider administrative actions, including patient biographical information, treatment, other medical history, insurance information, provider activities, lab results, charges for services, etc. that typically reflect healthcare information on a per patient basis. Particularly, ADT messages 35 may be generated and transmitted any time a patient has an encounter with a hospital 50, such as an admittance, discharge, transfer, to/from/within a hospital, and ADT messages 35 include this encounter information.

As shown in FIG. 1, healthcare information routing and demographics matching structure 30 may include an interface or router 32 that receives clinical feeds 36 and/or ADT messages 35 from hospitals 50. The router 32 may process or otherwise prepare data for entry into a database 21 and associated master patient index 31, which matches patient identifying information with content of database 21 to reconcile patient identity within health information exchange 15.

Subscribing participants 60 may access healthcare information stored in database 21 as indexed by master patient index 31 through healthcare information logic structure 20 in health information exchange 15 that is interfaced with healthcare information routing and demographics matching structure 30. Subscribing participants 60 may be, for example, physicians needing comprehensive healthcare information regarding patients who present at urgent care.

Two mechanisms may be provided in system 10 to provide information to subscribing participants 60. In one instance, subscribing participants 60 can login or otherwise access healthcare information logic structure 20 through a query portal 25. Subscribing participants 60 can enter queries 26 into portal 25, which is interfaced with healthcare information logic structure 20. Logic structure 20 may properly gather and/or associate data from database 21 with master patient index 31 based on the parameters of query 26 and any access/information rules applicable to system 10. In another instance, subscribing participants 60 may be delivered direct notifications 27, such as via email or alert every time an ADT message 35 or other healthcare update occurs to a patient.

### SUMMARY

Example methods and embodiments manage healthcare information in computer-based networks between healthcare sources and subscribers. Example methods can include transmitting subscriber requests to a healthcare notification system with a computer processor and associated transient memory and possibly persistent memory as well. The subscriber requests can include several different criteria for how and what notifications should be provided to subscribers by the system. In example methods, healthcare information about patients are also transmitted to the system from a source, like a health information exchange or healthcare database. With the requests and information, the system can perform a variety of functions that result in only responsive content provided to subscribers. For example, the system may filter the information against criteria in the subscriber requests, like patient biographical information, encounter types, or provider identity. Only when the information matches the criteria may it be provided, in desired format and fashion, to the subscriber who submitted the criteria. In doing so, the system can perform a meta-analysis on the received healthcare information itself and condition the provided information with this meta-analysis. For example, the system might look at retrieved healthcare information and change filtering behavior, correct or enhance the healthcare information, or provide additional information based on the healthcare information alone. Example methods may also use subscriber requests in such conditioning.

Example methods are useable in a variety of healthcare information settings and can work with multiple HIEs or other third-party databases providing information from clinical feeds, through ADT messages, over the Internet, etc. Example methods can also benefit a variety of different subscribers, including healthcare providers like primary care physicians, emergency rooms, specialists, physical therapists, home healthcare specialists, insurance providers, governmental agencies, and/or healthcare organizations.

Example networks include a computer processor and are communicatively connected to, and potentially control, subscribers and healthcare information sources. Example networks can include logic, intake, and notification modules that perform these name functions or execute example methods. For example, a network may acquire healthcare information based on actions with the patients at treatment facilities or encounters with healthcare providers, including things like ADT messages with admissions, transfers, discharges, and billing status changes. Because the alerts may be presented in massive amount and with varying quality of information, an example network may scrutinize the alerts against provided subscriber information to ensure that only and all responsive alerts are identified. An example network may then offer the filtered and comprehensive alerts to the properly-corresponding subscribers in any format, frequency, and manner desired. Example networks can also use the patient information and/or received healthcare information itself to improve data throughput and deliverables to the subscribers.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of a related art health information exchange system.

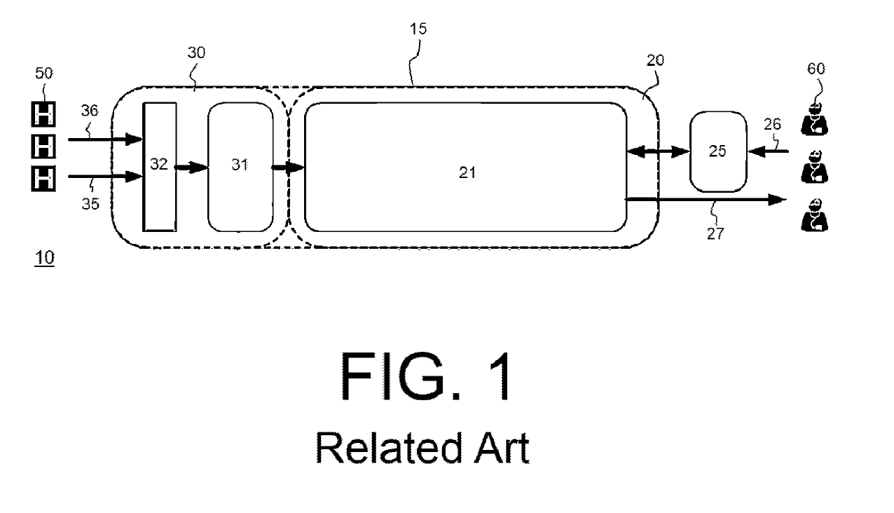

FIG. 2 is an illustration of an example embodiment healthcare notification system.

FIG. 3 is an illustration of another example embodiment healthcare notification system.

FIG. 4 is a flowchart of an example method of providing filtered healthcare notifications.

FIG. 5 is a flowchart of an example method of conditioning subscriber services based on healthcare information.

### DETAILED DESCRIPTION

This is a patent document, and general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when element(s) are referred to in relation to one another, such as being “connected,” “coupled,” “mated,” “attached,” or “fixed” to another element(s), the relationship can be direct or with other intervening elements. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “connected” for communications purposes includes all variations of information exchange routes between two devices, including intermediary devices, networks, etc., connected wirelessly or not.

As used herein, the singular forms “a”, “an,” and “the” are intended to include both the singular and plural forms, unless the language explicitly indicates otherwise with terms like “only a single element.” It will be further understood that the terms “comprises,” “comprising,” “includes,” and/or “including,” when used herein, specify the presence of stated features, values, steps, operations, elements, and/or components, but do not themselves preclude the presence or addition of one or more other features, values, steps, operations, elements, components, and/or groups thereof.

It should also be noted that the structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations. It should be presumed that any embodiment having features and functionality described below, in any workable combination, falls within the scope of example embodiments.

The following co-owned applications are incorporated by reference herein in their entireties: U.S. application Ser. No. 13/844,332 to Antony et al. filed Mar. 15, 2013 (Docket No. 3.0001.1); U.S. application Ser. No. 14/142,625 to Antony et al. filed Dec. 27, 2013 (Docket No. 3.0001.2); U.S. application Ser. No. 14/XXX,XXX to Antony et al. filed Feb. 25, 2014 (Docket No. 3.0002.1); and U.S. application Ser. No. 14/XXX,XXX to Antony et al. filed Feb. 25, 2014 (Docket No. 3.0003.1). Moreover, the example methods and embodiments of the incorporated documents are useable in whole and in part in addition to, or in replacement of, example systems and methods, including individual components, elements, structures, steps, connections, actions, data structures, functionalities, etc. thereof.

The inventors have recognized that existing healthcare notification systems do not have a method for accurately and consistently alerting relevant healthcare stakeholders, such as providers and payers, when patients, members, and/or citizen populations experience healthcare encounters. Existing systems may use information contained within an ADT message itself to route an alert to the appropriate recipient; however, ADT data often contains errors because it is commonly recorded by hand and relies on the information a patient relays at registration, sometimes under duress at an emergency room. Further, patients often do not provide or know all relevant information or may give incorrect information. The inventors have further recognized that existing systems may pass all ADT messages directly to providers identified therein, resulting in overwhelming volume and irrelevancy of information provided. This may cause recipients to become fatigued by constant and/or low-value messaging, resulting in less useful information for care management realized by existing systems.

The inventors have further recognized that other, more accurate sources of patient and healthcare information may be possessed by healthcare providers, insurers, governments, and other bodies not immediately performing healthcare services. This more accurate information can be solicited from providers as a means for filter messaging and also improve message content. Related art systems may not fully take advantage of the synergy between different healthcare information sources and providers to so enhance information delivery. Moreover, related art systems may not be sufficiently automated to deliver only responsive, high-quality messages at desired events or time intervals or to modify behavior of automated systems based on incoming healthcare information and/or subscriber requests. The below disclosure uniquely overcomes these and other problems recognized by the inventors in healthcare information networks.

The present invention is computer networks, software, and/or hardware that receive healthcare information and subscriber information and selectively provide notifications to subscribers based on these information and/or methods of doing the same. In contrast to the present invention, the few example embodiments and example methods discussed below illustrate just a subset of the variety of different configurations that can be used as and/or in connection with the present invention.

### Example Embodiments

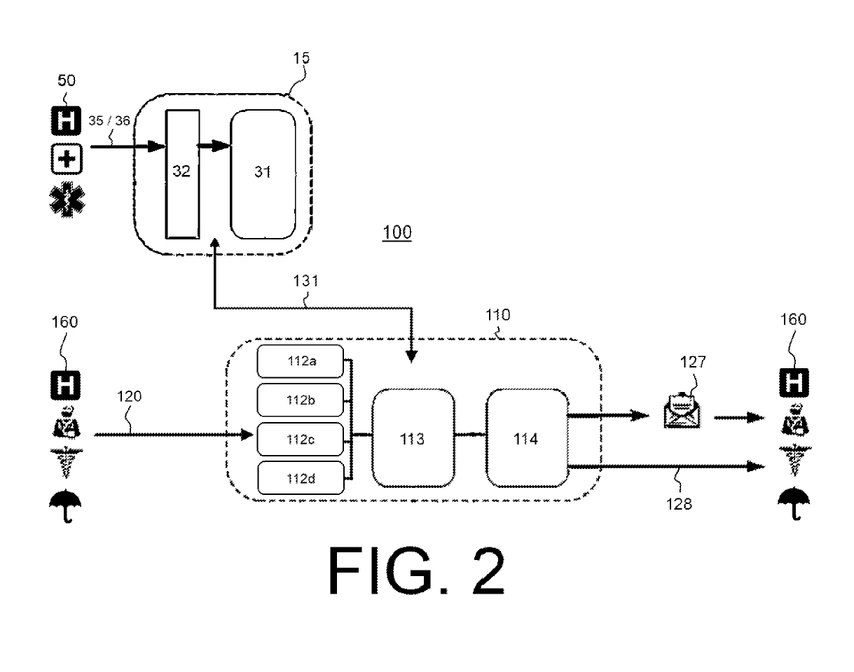

FIG. 2 is a diagram of an example embodiment healthcare notification system 100 that can be physically and logically configured through proper hardware infrastructure and/or software programming to provide targeted healthcare notifications and/or execute example methods of providing healthcare information. As shown in FIG. 2, example embodiment healthcare notification cluster 110 may be connected to a source of healthcare information, like a health information exchange (HIE) 15 in example embodiment system 100. Healthcare notification cluster 110 and HIE 15 may be co-located or remote, and may be connected via a dedicated connection or bus in a same setting or over great distances through networks such as VPNs, WANs, LANs, or the Internet.

Although example embodiment healthcare notification system 100 includes HIE 15 as a healthcare information source, it is understood that other types of sources for healthcare information are useable with example embodiments and methods. For example, a healthcare provider network system or other database having different data and interface configuration may be used in place of HIE 15. Still further, HIE 15 could be fully contained within healthcare notification cluster 110 to provide a centralized system for receiving, storing, processing, and/or delivering desired healthcare information to various subscribing providers 160. HIE 15 may be equally be remote and operated by a distinct actor, such as a state-operated database.

As shown in FIG. 2, healthcare notification cluster 110 is configured to receive subscriber information including subscriber parameters 120 from subscribing providers 160. Example embodiment healthcare notification system 100 is useable with a wide variety of subscribing providers 160, including primary care physicians, specialists, insurance providers, hospitals, labs, clinics, home healthcare providers, government entities etc. who may want or may be able to provide unique services with specific types of healthcare information, in specific formats, in specific circumstances.

Subscriber parameters 120 define at least some services and/or actions to be provided by example embodiment system 100. For example, subscriber parameters 120 may include a roster of patient information—including hospital identifier, member ID, any names, home address, city, state, zip code, date of birth, gender, ssn, phone numbers, membership status, etc. and/or portions thereof—identifying patients relevant to subscribers 160. For example, patient information submitted in parameters 120 may be associated with patients under the care of, covered by, and/or under the jurisdiction of subscribing providers 160. Other subscriber information may also be transmitted separately and/or as a part of subscriber parameters 120, including subscriber name, type, service level, enterprise or tax identification numbers, etc.

Subscriber parameters 120 may be input and/or updated into healthcare notification cluster 110 through a subscriber login interface, manually from subscriber parameters 120 that are delivered, such as from a spreadsheet via email, and/or automatically generated in cluster 110 based on a ruleset. For example, each subscribing provider 160 may provide subscriber parameters 120 to healthcare notification cluster 110 through any type of communication possible within a computer-processor-based network, including email, direct connection, manual input, etc. Subscribing providers 160 may provide multiple subscriber parameters 120 at signup and/or modify existing subscriber parameters 120, as their patients and needs and desires for healthcare information change.

Healthcare notification cluster 110 may include an input structure 112 to receive, process, and update/store information from subscriber parameters 120 in accordance with a transmission method used in example embodiment cluster 110. Input structure 112 may be, for example, a module or subroutine within healthcare notification cluster 110 or may be a dedicated server with independent processing capability, depending on the configuration of healthcare notification cluster 110. Alternatively, no separate input structure may be used, instead, a common processor and database may execute all functionality of input structures 112 along with all other functionality of healthcare notification cluster 110.

In example embodiment healthcare notification cluster 110 of FIG. 2, several input structures 112a-d are used, each with storage capability. Input structures 112a-d may be panels individualized to each subscriber 160; that is, each subscriber 160 may have a one-to-one assigned input structure 112x that stores subscription information, including subscriber parameters 120, only for the one assigned subscriber. In this way, an individual subscriber panel 112x can be created and/or updated for each subscriber 160, allowing for modular handling of subscriber information and interaction between subscribers 160 and cluster 110. It is understood that subscriber panels 112a-d may still share a common database or physical storage location, such as with separately-assigned memories, and/or may use different associations between numbers and types of subscribers 160 and input structures 112, aside from the one-to-one association between four subscribers 160 and four panels 112a-d shown in FIG. 2.

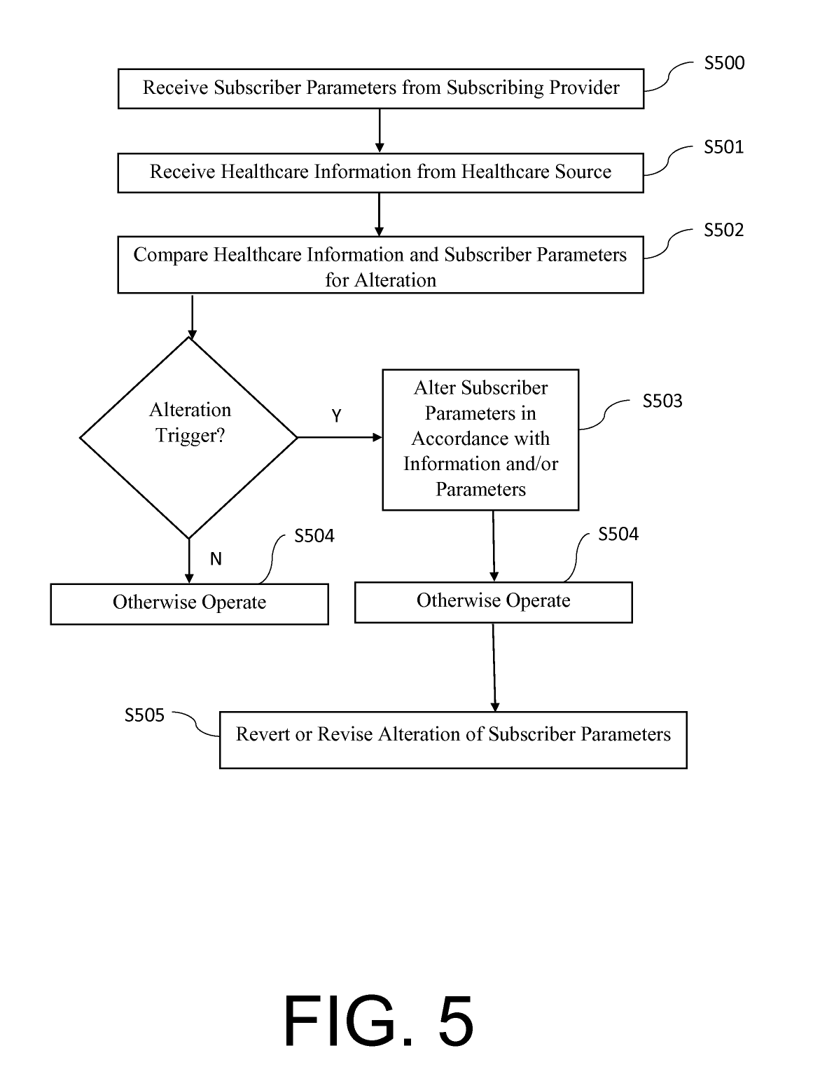

Subscriber parameters 120 stored by input structure 112 may include any kind of subscription information. As discussed above, subscriber parameters 120 may set out a roster of responsive client identification and/or a variety of circumstances for which subscribing providers 160 desire healthcare information, including any combination of events or message types based on which to create notifications, frequency of notifications, delivery format, type preferences, etc. For example, parameters 120 may include a limiting set of events or circumstances for which subscribing providers 160 desire healthcare information. Further, subscriber parameters 120 may include healthcare information formatting, delivery options, analysis, and/or enhancement selections. For example, subscriber parameters 120 may provide auto-subscription information to be used in the example method of FIG. 5, or may request additional analysis or methods to be performed by cluster 110.

As further specific examples, a subscribing provider 160 who is a specialist may want only healthcare information relating to patients under the care of the specialist who have an admit-type ADT message 35 created for a condition within the specialist's field of practice; or a subscribing provider 160 who is a large general practice of physicians may want cumulative healthcare information provided only once a month for a particular subset of very active patients; or an insurance provider as a subscribing provider 160 may want to be notified only when a certain type of encounter that reflects a need for patient contact or intervention occurs, such as multiple ER visits for a condition that may be successfully treated in an outpatient setting. All these limiting factors are examples of filters that may be present in subscriber parameters 120.

Alternatively or additionally, subscriber parameters 120 may be automatically generated based on rules of example embodiment system 100, such as for policy compliance or service reasons. For example, a default set of subscriber parameters 120 may be provided for subscribing providers 160 who provide incomplete or incorrect parameters. Or, for example, if a subscribing provider 160 is a hospital, subscriber parameters 120 may be automatically generated for the hospital to include all patients discharged within the past 60 days, either as a desired service or to comply with regulation. Such automatic generation may be performed by example embodiment cluster 110, such as by input structure 112, for example, by analyzing subscriber information, including subscriber parameters 120, for input reflecting a type of subscriber, comparing such input against a stored list of desired parameters based on type of subscriber, and updating/storing subscriber parameters 120 with the additional parameters.

Example embodiment healthcare notification cluster 110 is interfaced with a healthcare information source. For example, cluster 110 may include an HIE interface 131 that is configured to communicate with healthcare information sources, such as MPI 31, HIE interface 32, and/or entire HIE 15. Thus, cluster 110, via logic core 113 and/or a separate interface, may recognize and understand how to retrieve and read specific data structures or information association regimes present within MPI 31, such as client IDs, patient-identifying information, relationships among entries and records, etc., stored in MPI 31. Cluster 110 may further receive and process treatment and/or encounter information from providers 50 transmitted via feeds 36, including ADT messages 35.

As seen in FIG. 2, example embodiment system 100 may require only directed front-end interfaces with a healthcare source, like an external or third-party HIE 15, reducing complexity and/or potential for connection error problems that might exist were all other portions of exchange 15 having their own connection to healthcare notification cluster 110 or if a subscriber had to directly deal with and query exchange 15. Logic core 113, HIE interface 131, and/or any other communications interface configured to communicate with the healthcare information source(s) may be a central routine, specifically-configured processor, and or wholly individual server with storage and processor within healthcare notification cluster 110, for example, depending on the configuration of healthcare notification cluster 110.

Healthcare notification cluster 110 in example embodiment system 100 may also include a notification engine 114 controlled by logic core 113. As with each component of cluster 114, notification engine may be a functionality wholly programmed in logic core 113 or can be a separate module or even remote serve with its own processor and persistent and transient memory that is programmed or configured hardware to perform notification functionality in accordance with example methods or otherwise.

Notification engine 114 can prepare healthcare notifications from data anywhere in system 100, such as data derived from ADT messages 35, MPI 31, healthcare analysis stored in cluster 110, and/or any other healthcare information. Notification engine 114 may further provide the prepared information in a subscriber notification. Healthcare notifications may be delivered to subscribing providers 160 through a report 127 sent via email, over a direct or secure network, through the Direct standard, in HL7 format, via Internet services, or even hard copy, based on profile information 120 or other rules. Healthcare notifications may be structured as narratives, tables, spreadsheets, existing encounter formats, etc. by notification engine 114. For example, notification engine 114 may compile and email out a report of all healthcare information received, filtered, and/or formatted by logic core 113. Healthcare notifications may also be prepared and stored with notification engine 114 and provided to subscribing providers 160 only upon their access 128 to healthcare notification cluster 110; a reminder of a new healthcare notification may still be provided in this instance. Still further, a subscribing provider 160 may receive notifications via the Direct standard in real-time from notification engine 114.

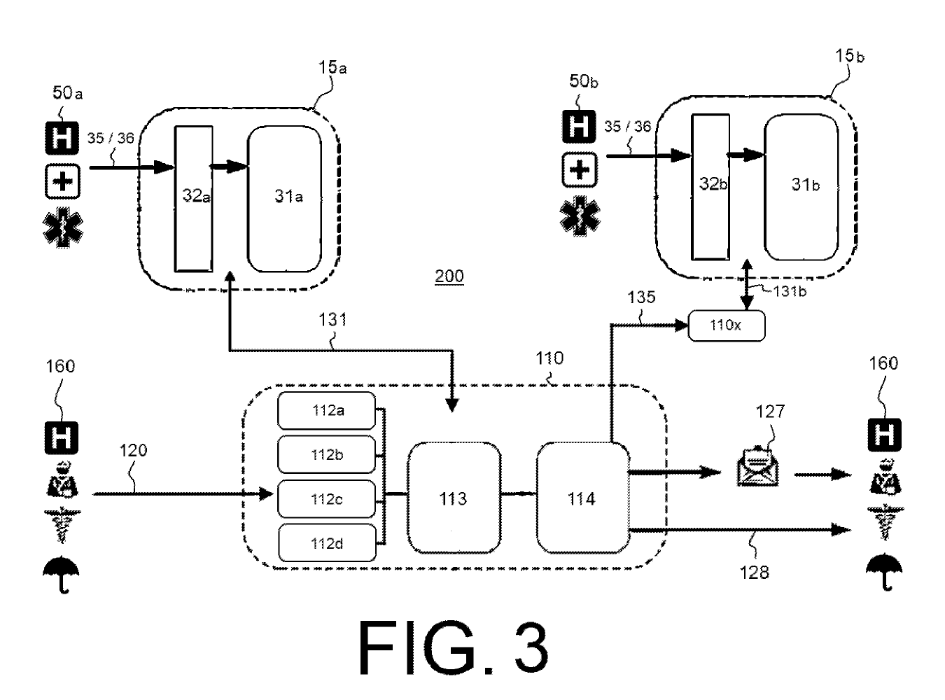

FIG. 3 is an illustration of another example embodiment healthcare notification system 200 useable to deliver desired healthcare to subscribers. Example embodiment system 200 may include several similar elements of example embodiment system 100 described in FIG. 2, redundant details of which are omitted. As shown in FIG. 3, multiple example embodiment healthcare notification clusters 110, 110x may be connected to several health information sources, such as health information exchanges or databases 15a and 15b compiled by separate states or hospital or insurance networks, for example. As such, example embodiment system 200 may be multiple systems 100, with merely an additional notification interface 135 activated between multiple clusters 110, 110x each associated with an exchange 15a, 15b.

As shown in FIG. 3, second exchange 15b may include an intake processor or router 32b to which notification engine 114 may provide healthcare information, including filtered or enhanced ADT messages originally received and processed from exchange 15a, to another cluster 110x associated with a different exchange 15b through notification interface 135. In this way, example embodiment systems may further share healthcare information and well-associated ADT messages through several different exchanges between which patients may move. Any number of example embodiment healthcare notification clusters 110 can operate between any number of healthcare sources, potentially propagating enhanced healthcare notifications or other information across several applicable exchanges. For example, exchanges 15a and 15b could be the same exchange, interfaced both through exchange interface 131 and notification interface 135, or dozens of exchanges like 15a and 15b could each be uniquely networked with example clusters 110x each through one or both of interfaces 131 and 135.

Although networked elements of example embodiment systems 100 and 200 are shown in FIGS. 2 and 3 as individual components with specific groupings and subcomponents, it is understood that these elements may be co-located in a single device having adequately differentiated data storage and/or file systems and processing configurations. Alternatively, the elements shown in FIGS. 2 and 3 may be remote and plural, with functionality shared across several pieces of hardware, each communicatively connected at adequate speeds to provide necessary data transfer and analysis, if, for example, more resources or better logistics are available in distinct locations. Given the variety of example functions described herein, healthcare notification cluster 110 may be structured in a variety of ways to provide desired functionality. Other divisions and/or omissions of structures and functionalities 112, 113, and 114 among any number of separate modules, processors, servers are useable with example embodiment systems 100 and 200, including execution on a single machine or among distant, exclusive servers and processors.

Similarly, although the example embodiment systems 100 and 200 of FIGS. 2 and 3 are systems that can be configured with and execute example methods, it is understood that example methods are useable with other network configurations, and systems 100 and 200 are useable with other methods of healthcare delivery.

Further, connections shown in example embodiment 100 can be over the Internet, including standard communications protocols such as TCP/IP, or through a programmed application configured to interact with and exchange data in dedicated network or intranet. Servers within example embodiment system 100 may include, for example, conventional domain and/or security and encryption protocols for access and authentication as well as processing capacities to retrieve, deliver, and/or format data for use within example embodiment system 100. Or, for example, all of example embodiment system 100 may be configured in a single machine, with an internal bus providing communication between various elements. Further, healthcare notification cluster 110 may also include its own data storage capabilities to handle and persist user inquiries and/or create a processed database mirroring in part data from separate MPI 31.

### Example Method 1

Based on healthcare information received from a healthcare information source and subscriber information, healthcare notification cluster 110 can collect, compile, enhance, analyze, and/or provide specific and well-tailored healthcare information for subscribing providers 160. As shown in FIG. 2, healthcare notification cluster 110 includes a logic core 113 interfaced with and/or controlling operation of HIE 15, input structure 112 including individual panels 112a-d, and/or notification engine 114. Logic core 113 may coordinate actions of example methods, including healthcare message processing and analysis, retrieval of healthcare information, delivering healthcare information in accordance with subscriber parameters, enhancement of MPI 31, and/or several other functions discussed further herein.

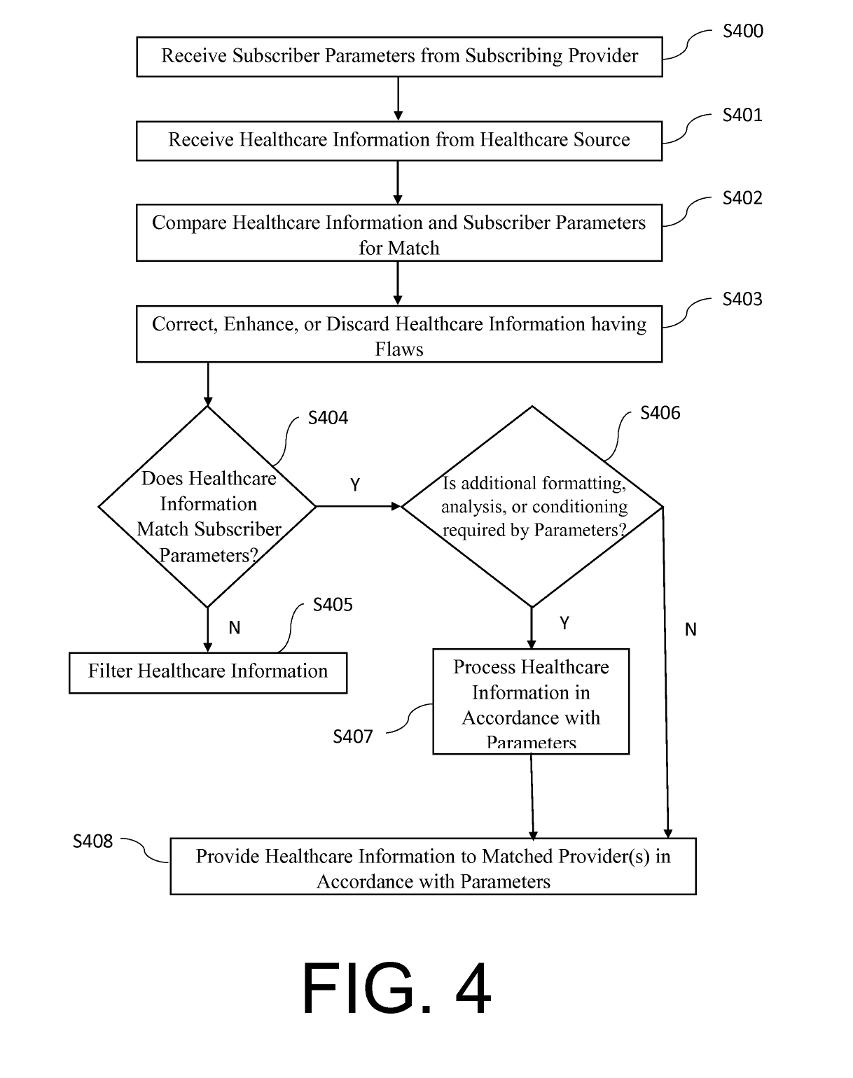

FIG. 4 is a flow chart illustrating an example method of healthcare information and notification processing. Using an example network 100 from FIG. 2, logic core 113 may provide healthcare message processing in the example method of FIG. 4. In S400, subscriber parameters 120 are received from one or more subscribing providers 160. S400 may be executed before, after, and/or in real time with other actions in example methods, such that subscriber parameters 120 may be updated whenever, automatically or at a discretion of a subscriber 160 or other ruleset or actor. In S400, receiving subscriber parameters 120 may further include processing and/or storing such parameters by an input structure 112, such as in input structure/panel 112b associated with the subscriber 160.

In S401, healthcare information is received from a source. For example, incoming notifications/information to HIE 15 may be monitored and/or received by healthcare notification cluster 110 through interface connection 131. Incoming messages may include standard or enhanced ADT messages 35 or other information from clinical feeds 36, for example. In S401, several messages from several different sources may be received, and receiving S401 may include processing and/or storing received healthcare information, for example, to extract relevant patient data and/or decrypt or arrange data therein based on message type and source configuration. Although the default rule for all actions, S401 and S400 may occur in any order, given proper persistence of subscriber information and healthcare information in a network executing an example method.

In S402, the received healthcare information in S401 and received subscriber parameters in S400 are compared to determine further treatment of the information. For example, in S402, logic core 113 may compare a patient identifier in a received ADT message 35 against client-identifying information, such as a name, address, patient ID, birthdate, SSN, etc. and/or portions thereof, from a roster processed by input structure 112 from client parameters 120 so as to identify messages relating to a responsive client, e.g., one in a roster from a subscriber.

Logic core 113 may determine which messages are responsive to a provider's roster based on the comparison in S402. Further, because partial information and several different types of healthcare information may be compared in S402, partial or some incorrect information being present in ADT message 35 or picked up from MPI 31 or incorrectly input into a clinical feed 36 may not prohibit a proper match between received healthcare information and with subscription parameters 120.

In S403, the received healthcare information from S401 can be corrected and/or enhanced, potentially based on the comparison in S402. For example, logic core 113 may further process received ADT messages 35 provided from HIE 15 to discard those messages or portions of messages containing duplicate, incorrect, or low-value contents. For example, a provider 50 may generate an ADT message 35 for an internal transfer that has no meaning outside the provider facilities, or a received healthcare information may include typographical errors in a patient's information or an impossible/redundant administrative status change, such as duplicative admittances for the same patient and facility. Logic core 113 may analyze received healthcare information for such errors, for example, under internal rules for eliminating impossible types of actions, clear typographical errors, or unusable data in S403.

Similarly, in S403, additional information and associations can be added to the healthcare information, based on other information in or available to the enhancer. This process may be similar to that discussed in example method 3 below. For example, HIE 15 may autonomously or under the direction or query of logic core 113 associate ADT message 35 or other clinical feed data with other patient information, like record numbers, biographical information, health history information, citizenship records, etc. Such enhancement in S403 may occur before receipt of healthcare information and/or concurrently or after matching and/or correction in example operations.

Additionally or alternatively, logic core 113 may analyze received healthcare information for errors and/or incompleteness by comparing information content against known correct client information, such as the higher-reliability information in subscriber parameters 120. Subscribing providers 160 may be under less duress and/or exercise greater business care in fully and/or properly identifying patients and related healthcare information in their parameters 120. Further, parameters 120 may be curated and re-checked over a history of received messages and other healthcare information, offering a more accurate source of contextual information and data associations therein. Incorrect or useless messages or portions of the information identified in S403 under any approach may be corrected or disposed of without further storage, processing, and/or passing them on to subscribing providers 160. Similarly, incomplete or brief information may be completed or enhanced for more useful analysis and consumption under any approach in S403.

In S404, if there is a match from the comparison of S402, the matching received information, potentially corrected and/or enhanced from other information in S403, can be prepared for or forwarded to the matching subscriber. If there is not a match in S404, the received information may be filtered out in S405, by being discarded or otherwise held without being forwarded to a subscriber. For example, in S404, logic core 113 may determine that a received ADT message 35 for a discharge from a specialist facility does not match any subscriber parameter 160, because, for example, the patient in the ADT message is not identified in any rosters stored in input structures 112, and/or because the specialist-discharge event is not matched or is specifically excluded from parameters 120 in input structures 112. In this instance, logic core 113 may not forward the information on to notification engine 114, and no provider may be bothered with the non-matching information. Or for example, logic core 113 may determine that the ADT message 35 matches in relevant part with subscriber parameters 120 for multiple subscribing providers 160. In this instance, logic core 113 may forward the information on to notification engine 114 and/or further process the information to be provided to the multiple matched providers.

In S406, matching healthcare information may be further compared against additional subscriber requirements and, in S407, processed based on subscriber parameters. For example, logic core 113 may also process incoming information against subscriber parameters 120 in order to determine if messages 35 are responsive to subscriber needs set out in parameters 120. Logic core 113 may format and time any notifications generated based on a positive match on parameters 120. For example, subscribing providers 160 may provide notification limitations within parameters 120, such as a special formatting for particular types of encounters and/or patients. Logic core 113 may further compare such notification limitations against each ADT message 35 to format noncompliant information and forwarded those complying with subscriber's notification limitations to notification engine 114 to make available to the subscriber in accordance with any other client parameters such as delivery format or frequency.

As a further example of S407, logic core 113 may control notification engine 114 to generate healthcare notifications only at appropriate instances based upon subscriber parameters 120. For example, whenever logic core 113 monitors an ADT message 35 generated based on a client encounter for a client included in a roster in subscriber parameters 120, a healthcare notification may be generated for the subscribing provider 160. Alternatively, if subscriber parameters 120 requested notifications only at weekly intervals, a notification of the encounter observed in the ADT message 35 may be held until the requested interval has passed.

In S408, the received, and potentially corrected and enhanced, healthcare information is provided as a notification only to matching subscribing providers, potentially following processing and formatting. Healthcare notifications generated inS408 may include a wide variety of detail based on subscriber parameters and available healthcare information. For example, healthcare notifications may include only the ADT message content that triggered the notification, or healthcare notifications may include any or all healthcare information identified in MPI 31 for a patient whenever a responsive notification is generated for that patient. Subscriber parameters 120 may indicate a level and type of information requested in healthcare notifications; for example, a subscribing provider 160 may list internal identifiers, name of a primary care provider, record number, and/or any other contextual information to aid their bookkeeping that can be added into notifications by engine 114.

As another example of S408, logic core 113 may select particularly high-value or relevant healthcare data for inclusion in a notification. For example, an insurance provider can submit subscriber parameters 120 requesting notifications for treatment or prescription changes, and example embodiment system 100 may provide a notification to the provider each time an ADT message 35 contains an encounter with a changed treatment or prescription; the notification may also contain information about a new condition or hospital encounter that resulted in change if this information is determined as relevant or important, for, say, determining whether the new prescription is effective or wasteful, by the logic core 113.

Notification engine 114 can prepare healthcare notifications including data present solely in healthcare notification cluster 110, such as data stored in a local database that was filtered from ADT messages 35 and MPI 31 by logic core 113, or with information accessible anywhere in example embodiment system 100. For example, cluster 110 may have previously identified several different data entries relating to a particular patient in MPI 31. Notification engine 114 may pull and combine all requested information among the previously-identified information in MPI 31 for presentation in a subscriber notification in S408.

Healthcare notifications may be delivered to subscribing providers 160 through a report 127 sent via email, over a direct or secure network, through the Direct standard, in HL7 format, via Internet services, or even hard copy, based on profile information. Healthcare notifications may be structured as narratives, tables, spreadsheets, existing encounter formats, etc. For example, a subscribing provider 160 may have requested a daily notification in HL7 format for a list of active patients in parameters 120, and notification engine 114 may compile and email out a report of all encounters in HL7 format for the identified patients within a daily interval.

Alternatively, in S408, healthcare notifications may be prepared and stored with notification engine 114 and provided to subscribing providers 160 only upon their access 128 to healthcare notification cluster 110; a reminder of a new healthcare notification may still be provided in this instance. Still further, a subscribing provider 160 may receive notifications via the Direct standard in real-time, permitting providers to readily follow-up with patients at each encounter, such as admission or discharge.

It is understood that several aspects of the methods possible from the flowchart of FIG. 4 are optional and may occur only in specific conditions. For example, only S400, S401, S402, S404, and S405 may occur in the event of basic healthcare information filtering, such as when encounters from an HIE are received that do not match with any subscribing provider's parameters. Or, for example, S400, S401, S402, S403, S404, S406, S407, and S408 may all occur when healthcare information is received that is responsive to a subscriber's parameters, is eligible for correction based on additional information, and contributes to further analysis and formatting prior to being sent out as defined by subscriber parameters. Several other action permutations are of course possible. As such, subscribing providers 160 may receive responsive, well-tailored healthcare notifications only in accordance with their parameters through example methods, while avoiding the universe of healthcare information that is not responsive to provider needs.

### Example Method 2

Another example method may be a specific function for S407 of FIG. 4, where historical analysis on healthcare information is performed and provided to subscribers. For example, cluster 110 and/or logic core 113 may be programmed or otherwise configured to store received healthcare information over time and analyze/provide the stored information for subscribers, based on parameters. For example, subscriber parameters 120 may request additional information be added to notifications 128/127 beyond healthcare information received from exchanges 15 or subscribers 160, or such information may be added by default, based on subscription type, default ruleset, etc. Logic core 113 may check for a need for such additional information in S406 and perform and add the additional analysis in S407.

For example, cluster 110 may track and store individual ADT messages 35 that matched in S404, or may tally information contained in the same. For example, cluster 110 may include a separate persistent storage device. Each ADT message 35 that matches with subscriber rosters in S404 can be identified by type, and the types may be tallied over time for each patient in the matched ADT. For example, cluster 110 may store a sum of all discharges for a particular patient identified in a subscriber panel; this tally may be gathered from discharge-type ADT messages 35 for that patient over time. Of course, other metrics and analysis may be equally conducted and stored, including event-versus-date type charts, fitting of events against known pathologies and warning conditions, and/or tracking all activity for a particular type or subset of patients requested by subscribers over time.

The analysis performed in S407 may be executed universally, on all received healthcare information or on only matched healthcare information regardless of parameter content, and provided selectively based on subscriber parameters 120. For example historical analysis may be executed only selectively when requested by subscriber parameters 120 to reduce processor and storage load in cluster 110.

In this example method, in S407, the stored analysis may be added to a notification 127/128, for example, by notification engine 114, if requested by parameters 120. Subscribing providers 160 may then receive this additional analysis along with the forwarded healthcare information or at another independent time. For example, as s subscribing provider 160 receives filtered notifications for a requested patient identified in their parameters 120, the notifications may further include a sum of all discharges for the requested patient, if further requested by the parameters 120.

### Example Method 3

Another example method can enhance healthcare information stored with a healthcare information source, like HIE 15. For example, MPI 31 can be enhanced with additional healthcare information from subscriber information and/or other healthcare sources and information. Using the example network of FIG. 2, example embodiment cluster 110 and/or logic core 113 may provide MPI 31 with client-identifying entries from subscriber parameters 120. The client-identifying entries may be stored in MPI 31 to associate correct patient information with incoming data. For example, an existing MPI 31 may include data of a patient's name and address indexed to some other patient data in a database, with data of the patient's social security number, date of birth, and gender indexed to other patient data. Logic core 113 may provide all correct and comprehensive patient information known from subscriber parameters 120 to MPI 31 via interface 131 so that full patient-identifying information may be correctly matched with existing indices stored in MPI 31 and correctly associated with patient data.

As a further example, when exchange 15 provides ADT messages 35 to healthcare notification system 110 or otherwise, such ADT messages 35 may be enhanced with associated information from MPI 31, either automatically or by querying the MPI 31 with information in the ADT message 35. If MPI 31 has otherwise been updated with subscriber information associated with healthcare information stored therein, such enhancement may fully pick up all related subscriber and healthcare information for a patient for handling in example systems 100 and 200 and/or example methods. By properly enhancing and associating all information from subscribers and sources, all information may properly correspond wherever stored, and information retrieved from either a subscriber or a source may be more complete.

### Example Method 4

FIG. 5 is a flow chart of another example method. In the example method of FIG. 5, subscriber information itself, as well as actions taken based on the same, may be modified based on healthcare information received from a healthcare information source. Thus, both example methods 2 and 4 include creating new data for subscribers based on received healthcare information, which may be considered metadata with regard to the healthcare information. This new data persists within a core over time, and notifications provided to subscribers are further modified based on this stored data.

For example, as shown in FIG. 5, subscriber parameters may be received S500, and healthcare information may be received S501 in a same cluster. S501 and S500 may occur in any order, given proper persistence of subscriber information and healthcare information. For example, for S501 a discharge-type ADT message 35 may be generated by a hospital 50 and transmitted through HIE 15 to cluster 110 via interface 131 in the example embodiment system 100 of FIG. 2. And for S500, subscriber parameters 120 from the hospital as a subscriber 160 may be transmitted to cluster 110 and processed by input structure 112a.

In S502, the received healthcare information is compared against subscriber information to determine if subscriber information should be altered. The comparison in S502 may look at patient rosters for identifying information, event type, and/or preferences defined by subscriber parameters 120 to determine when alteration is appropriate. For example, logic core 113 of FIG. 2 may compare the received ADT message 35 against subscriber parameters 120 stored in panel 112a for the hospital subscriber 160. The subscriber parameters 120 may include a flag, bit, or other entry requesting all further healthcare events for any patient being discharged from the hospital 50 be provided to hospital 50. That is, a subscriber may request “auto-subscription” for a patient(s) that, upon occurrence of the auto-subscription event, causes all further information for that patient(s) to be forwarded to the provider just as if the provider had included the patient in the original parameters for notifications.

In S503, the subscriber information is altered based on a positive outcome of comparison S502. Continuing the above example, upon matching the discharge-type ADT message 35 with an auto-subscription request in subscriber parameters 120 for that type of message, logic core 113 may alter subscriber parameters 120 in panel 112a to include the patient identified in the matched ADT message as a patient for whom all healthcare information should be forwarded. For example, in FIG. 4, future ADTs received for that patient may generate a “Yes” response in S404 following S503. Logic core 113 may use the matched notification itself or other information, such as other enhanced ADT messages and/or other example methods of acquiring healthcare information, to supply information, including enhanced and/or corrected information, about the patient identified in the qualifying ADT message into panel 112a. Or, for example, a default ruleset in cluster 110 may trigger auto-subscription whenever a specific type of encounter is matched with a specific type of provider, such as admit-type ADT messages for hospitals. In that example, when an admit encounter for a hospital provider is processed in S502, the hospital's parameters may be modified to generate a match for all healthcare information received for the patient going forward, regardless of the hospital's input.

In S503, the subscriber information may be further altered with expiration or reversion information if a positive outcome is determined in S502. In the example, logic core 113 may add an expiration timeframe or event to the auto-subscribed patient information added to panel 112a. For example, a flag indicating the patient identified in the matched ADT message should be removed after 3 months in subscriber panel 112a may be added to subscriber parameters. Or, for example, a routine for removing the patient after 1 month of inactivity (such as no matching healthcare information received in cluster 110 for 1 month), or removing the patient upon an ADT message showing admission to a different facility, may be activated in panel 112a. As a yet further example, an add date for the auto-subscription may be added to panel 112a, and core 113 may compare dates of later encounters or healthcare information receipt with the add date. If the difference falls outside of a default or subscriber-provided window, no further action may be taken, as if no match in S402, S404, and/or S502 was detected.

In S504, other operations or example methods, such as the example method of FIG. 4, may be executed, and such execution may be based on the altered subscriber information (or without alterations, as the case may be). For example, logic core 113 and notification engine 114 may forward encounter notifications for the matched patient to the auto-subscribed provider 160 based on the altered subscriber information 120 in input structure 112a. In S504, it is still possible that no notifications may be generated, because no eligible healthcare notification is received and/or modified subscriber parameters otherwise dictate that nothing should occur.

In S505, altered subscriber information may be reverted or further altered. For example, if any reversion or expiration information or routine is added/activated in S503, subscriber information may be reverted when the conditions in the associated reversion information are met. Alternatively, original subscriber parameters or a default rule in cluster 110 may determine when alterations from S503 should expire or otherwise be further modified. In the specific example, logic core 113 may receive no healthcare notifications for the matched, “auto-subscribed” patient from S502 and S503 for six months, and the original or altered subscriber parameters 120 may indicate that such auto-subscriptions are to terminate after 6 months of inactivity. Or, for example, a default ruleset in cluster 110 may indicate that all “auto-subscriptions” are to be terminated from three months from the subscribing event, regardless of activity.

Still further, parameters 120 or default rulesets in cluster 110 may terminate or alter auto-subscriptions upon the occurrence of certain events, such as a patient reaching a certain age, an encounter indicating a patient death, a specific type of ADT message, etc. When the criteria are met in S505, logic core 113 may remove the patient information from 112a and/or revert subscription parameters in 112a to a status as if the alteration in S503 had not occurred. Other methods and logic core operations may then proceed using the new subscriber parameters generated in S505.

Some example methods being described, it is understood that one or more example methods may be used in combination and/or repetitively to produce multiple options and functionalities for subscribers. Example methods may be performed by properly programming or hardware configuring notification networks to receive healthcare information and subscriber information and act in accordance with example methods. Similarly, example methods may be embodied on non-transitory computer-readable media that directly instruct computer processors to execute example methods and/or, through installation in persistent memory, configure general-purpose computers connected to subscribers and healthcare information sources into specific healthcare notification networks that execute example methods.

Example methods and embodiments thus being described, it will be appreciated by one skilled in the art that example embodiments may be varied through routine experimentation and without further inventive activity. For example, subscribers are described as providing subscriber parameters to define the parameters of their information delivery service, it is understood that subscriber parameters may be automatically received in example embodiment networks for any subscriber through default options, a controlling ruleset, or through other controlling subscribers. Variations are not to be regarded as departure from the spirit and scope of the exemplary embodiments, and all such modifications as would be obvious to one skilled in the art are intended to be included within the scope of the following claims.

What is claimed is:

1. A method of managing healthcare information with a computer processor-based healthcare notification delivery network, the method comprising:
receiving, at the healthcare notification delivery network, subscriber parameters for a subscriber;
receiving, with the healthcare notification delivery network, healthcare information from a healthcare information source;
comparing, with the healthcare notification delivery network, the healthcare information with the subscriber parameters;
creating, with the healthcare notification delivery network, new healthcare information in the healthcare notification delivery network, wherein the new healthcare information is derived from and different from the healthcare information; and
providing, with the healthcare notification delivery network, a healthcare notification to the subscriber, wherein the healthcare notification includes at least a portion of the healthcare information, and wherein the providing is executed using the new healthcare information and only if the comparing determines that the healthcare information matches the subscriber parameters.

2. The method of claim 1, wherein the new healthcare information is a new subscriber parameter and a historical analysis of the healthcare information.

3. The method of claim 1, wherein the new healthcare information is a new subscriber parameter, wherein the new subscriber parameter is new patient-identifying information associated with the subscriber and present in the healthcare information, the method further comprising:
second receiving, with the healthcare notification delivery network, second healthcare information from a healthcare information source;
second comparing, with the healthcare notification delivery network, the second healthcare information with the subscriber parameters; and
second providing a healthcare notification to the subscriber, wherein the second providing is executed only if the comparing determines that the second healthcare information matches the new patient-identifying information, and wherein the second receiving, comparing, and providing are executed after the creating.

4. The method of claim 3, wherein the creating stores the new patient-identifying information in a persistent memory associated with the subscriber.

5. The method of claim 4, wherein the second providing is executed months after the creating.

6. The method of claim 4, further comprising:
removing the new patient-identifying information from the persistent memory.

7. The method of claim 6, wherein the removing is executed based on at least one of a condition in the subscriber parameters, a threshold passage of time stored in the healthcare notification network, and a non-occurrence of the second providing.

8. The method of claim 1, wherein the creating is executed only if requested by the subscriber parameters.

9. The method of claim 1, wherein the new healthcare information is a historical analysis of the healthcare information based on the healthcare information and previously-received healthcare information, and wherein the healthcare notification includes the historical analysis.

10. The method of claim 9, wherein the analysis is a sum of the healthcare information and the previously-received healthcare information, and wherein the healthcare information and the previously-received healthcare information all match the subscription parameters.

11. The method of claim 10, wherein the analysis is a sum of only discharge-type ADT messages in the healthcare information and the previously-received healthcare information.

12. The method of claim 1, wherein the healthcare information is a record, created by the healthcare source and received by the healthcare notification delivery network, and wherein the record is created and received only when the healthcare source completes an action in response to a request for medical treatment.

13. The method of claim 12, wherein,
the subscriber is operated and controlled by a separate operator and controller from the healthcare notification delivery network,
the receiving subscriber parameters occurs before and independent of the receiving healthcare information and the subscriber parameters are received directly from the subscriber,
the subscriber is at least one of an insurance provider, a healthcare provider, and a government entity,
the healthcare information is an ADT message generated in response to a patient encounter with the healthcare source,
the healthcare notification includes information contained in the ADT message,
the new healthcare information is at least one piece of information selected from a group of a new subscriber parameter and a historical analysis of the healthcare information, and
the creating is executed only if requested by the subscriber parameters.

14. A healthcare notification delivery network comprising:
a persistent memory configured to store meta healthcare information; and
a computer processor connected to a healthcare information source and a providing subscriber, wherein the processor is configured to,
receive healthcare information from the healthcare information source,
receive subscriber parameters from the providing subscriber,
compare the healthcare information with the subscriber parameters,
create the meta healthcare information in the persistent memory, wherein the meta healthcare information is derived from and different from the healthcare information, and
provide a healthcare notification to the subscriber, wherein the healthcare notification includes at least a portion of the healthcare information, and wherein the providing is executed using the meta healthcare information and only if the comparing determines that the healthcare information matches the subscription parameters.

15. The network of claim 14, wherein the meta healthcare information is at least one piece of information selected from a group of a new subscriber parameter and a historical analysis of the healthcare information, and wherein the processor is further configured to create the meta healthcare information only if requested by the subscriber parameters.

16. The network of claim 14, wherein the meta healthcare information is patient-identifying information from the healthcare information that was not previously present in the subscriber parameters, and wherein the processor if further configured to,
second receive second healthcare information from a healthcare information source,
second compare the second healthcare information with the subscriber parameters, and
second provide a healthcare notification to the subscriber only if the second healthcare information matches the patient-identifying information after the meta healthcare information is created.

17. The network of claim 16, wherein the processor is configured to second provide the healthcare notification months after the meta healthcare information is created, and wherein the processor is configured to remove the meta healthcare information from the persistent memory based on at least one of a condition in the subscriber parameters, a threshold passage of time stored in the healthcare notification network, and the second healthcare information not matching the patient-identifying information.

18. The network of claim 14, wherein the meta healthcare information is a historical analysis of the healthcare information based on the healthcare information and previously-received healthcare information, and wherein the healthcare notification includes the historical analysis.

19. The network of claim 18, wherein the analysis is a sum of only discharge-type ADT messages in the healthcare information and the previously-received healthcare information, and wherein the healthcare information and the previously-received healthcare information all match the subscription parameters.

20. A non-transitory computer readable medium, wherein the medium includes data structures that instruct a computer processor to,
receive subscriber parameters for a subscriber;
receive healthcare information from a healthcare information source;
compare the healthcare information with the subscriber parameters;
create new healthcare information derived from and different from the healthcare information; and
provide a healthcare notification to the subscriber, wherein the healthcare notification includes at least a portion of the healthcare information, and wherein the providing is executed using the new healthcare information and only if the comparing determines that the healthcare information matches the subscription parameters.
